(19) United States
(12) Patent Application Publication
(10) Pub. No.: US 2019/0234126 A1
(43) Pub. Date: Aug. 1, 2019

(54) HYDRAULIC PIVOT FOR DOORS

(71) Applicant: Oscar RODRIGUEZ RODRIGUEZ, Benito Juarez. Quintana Roo (MX)

(72) Inventor: Oscar RODRIGUEZ RODRIGUEZ, Benito Juarez. Quintana Roo (MX)

(21) Appl. No.: 16/313,834

(22) PCT Filed: Nov. 7, 2016
(86) PCT No.: PCT/MX2016/000114

§ 371 Date: Dec. 27, 2018

(30) Foreign Application Priority Data
Jul. 4, 2016 (MX) MX/U/2016/000273

(51) Int. Cl. E05D 7/081; E05F 3/20

(52) U.S. Cl. CPC E05D 7/081; E05Y 2900/132; E05F 3/20

(57) ABSTRACT

A HYDRAULIC PIVOT FOR DOORS THAT INCLUDES A LOWER PIVOT AND A PULLEY SYSTEM THAT SPINS AT OPENING TIME AND AT CLOSING TIME, TWO SPRINGS THAT PROVIDE THE STRENGTH AND THRUST AT THE DOOR'S OPENING TIME AND AT THE DOOR'S CLOSING TIME, TWO VALVES THAT REGULATE THE CLOSING SPEED AND THE BREAK'S SPEED. A SECOND LOWER PIVOT THAT IN ITS INTERIOR COMPREHENDS A SCREW BOLT WITH A SUPERIOR HOLE, WHERE IT HOUSES AN ARROW WITH A WRENCH'S COUPLING OPENING; THE ARROW IN ITS INTERIOR HOUSES A LENGTHLY SPRING, THAT WHEN IT IS ACTIVATED VIA THE WRENCH THAT WITH A SPIN TO THE RIGHT PRESSES THE SPRING THAT IT MAKES THE SCREW BOLT GO UP OR DOWN THE SCREW BOLT TO THE NEEDED HEIGHT UNTIL IT SHEATHES IN THE TOP STRIKE. PLATE THAT ALLOWS THAT THE HYDRAULIC PIVOT PROVIDE WEIGHT SUPPORT UP TO 100 KILOGRAMS, AND PROVIDES OPENING/CLOSING DOOR CONTROL.

### TECHNICAL FIELD

THE PURPOSE OF THIS INVENTION, AS SEEN AS IT IS EXPRESSED IN THIS DESCRIPTION'S STATEMENT, IT MAKES REFERENCE TO A HYDRAULIC PIVOT USED FOR DOORS.

### DESCRIPTION OF THE INVENTION

THE NOVELTY OF THIS INVENTION IS CLEARLY SHOWN IN THE DRAWINGS THAT ARE ATTACHED WITH CURRENT APPLICATION, AND ACCORDING TO THE DESCRIPTION THAT WE IN DETAILED DESCRIBED SO THAT THE ALPHA-NUMERIC REFERENCES CORRESPOND TO EACH OF THE STRUCTURAL ELEMENTS THAT SHAPE THIS INVENTION.

### BRIEF DESCRIPTION OF THE FIGURES

FIG. 1 A DISASSEMBLED VIEW OF THE LOWER HYDRAULIC PIVOT, AND THE STRUCTURAL PARTS THAT IT IS MADE OF.

FIG. 2 IS AN INTERNAL DISASSEMBLED VIEW OF THE LOWER HYDRAULIC PIVOT, AND THE STRUCTURAL PARTS THAT IT IS MADE OF.

FIG. 3 IS A PERSPECTIVE VIEW OF THE LOWER HYDRAULIC PIVOT.

FIG. 4 IS AN INTERNAL DISASSEMBLED VIEW OF THE TOP HYDRAULIC PIVOT, AND THE STRUCTURAL PARTS THAT IT IS MADE OF.

FIG. 5 IS A PERSPECTIVE VIEW OF THE TOP HYDRAULIC PIVOT.

FIG. 6 IS A PERSPECTIVE VIEW OF THE STRIKE PLATE'S TOP HYDRAULIC PIVOT.

### INDETAILED DESCRIPTION OF THE INVENTION

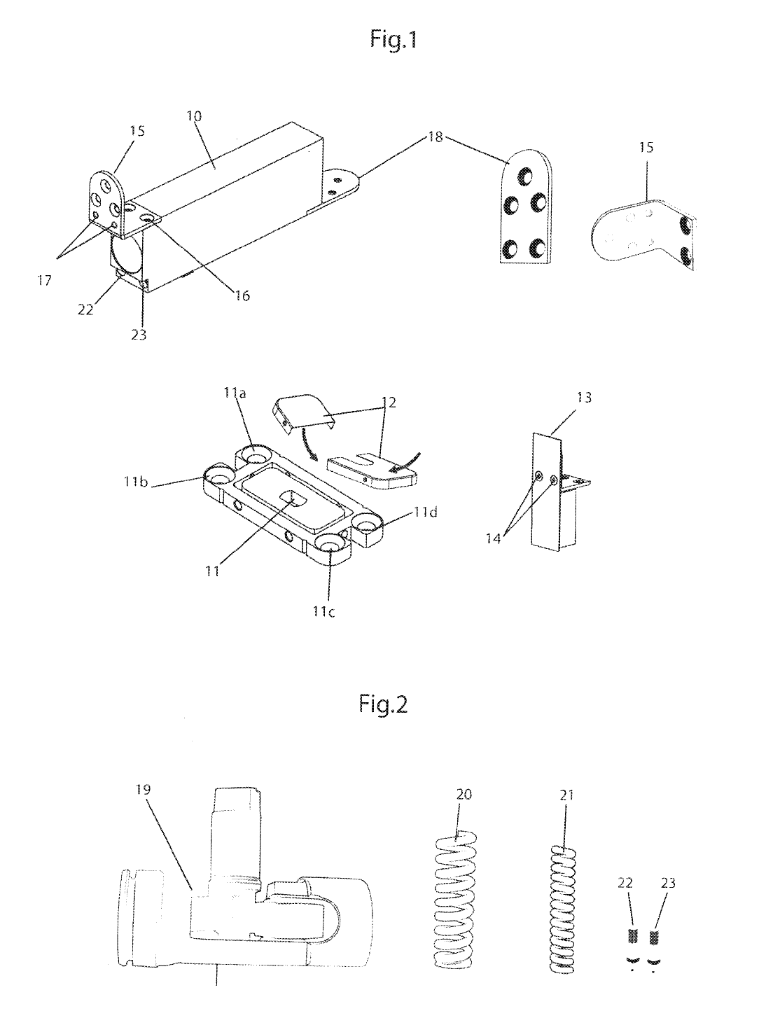

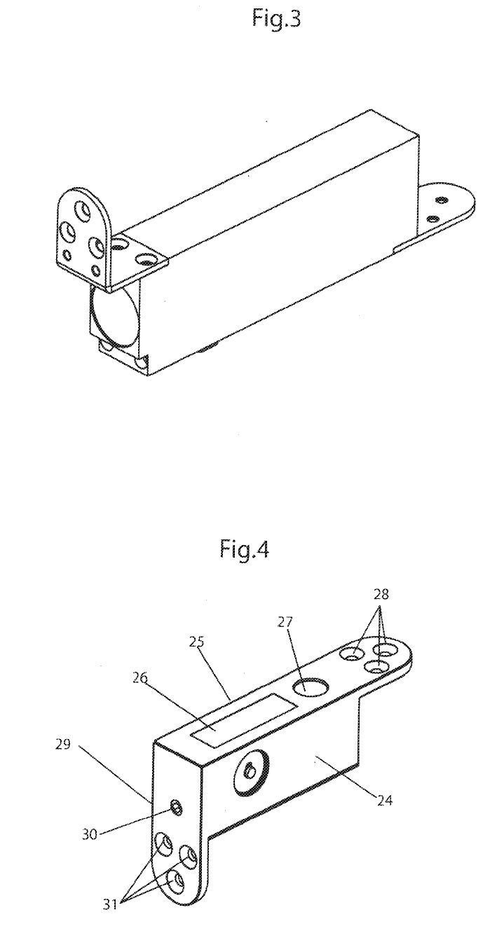

WITH REFERENCE TO FIG. 1, THE HYDRAULIC PIVOT FOR DOORS CHARACTERIZED BY A LOWER PIVOT THAT COMPREHENDS A RECTANGULAR HOUSING BODY (10), A STRIKE PLATE WITH A CENTRAL OPENING (11) THAT COMPREHENDS FOUR HOLES (11a, 11b, 11c, 11d), AND FOUR ADJUSTMENT SCREWS THAT COMPRENHEND A THREADED REGION (12) COUPLING TO THE HOLES; FOUR METAL STUDS THAT COMPRENHEND AN THREADED-ASSEMBLY REGION (NOT ILLUSTRATED), TWO PROTECTIVE TOPS (12), A LEFT PROTECTIVE LAMINATED-PLATE (13) WITH TWO HOLES LOCATED IN THE LOWER PART (14) AN ASSEMBLY SQUARE-SHAPE LAMINATED-PLATE (15) WITH TWO HOLES LOCATED IN THE LOWER PART (16), TWO ASSEMBLY HOLES LOCATED IN THE COUPLING TOP PART (17) WITH A LATERAL LAMINATED-PLATE (13); A LAMINATED-PLATE WITH A SEMICIRCLE TERMINATION (18) THAT COMPREHENDS FIVE COUPLING HOLES.

WITH REFERENCE TO FIG. 2, THE HYDRAULIC PIVOT FOR DOORS CHARACTERIZED BECAUSE THE RECTANGULAR HOUSING BODY COMPREHENDS A CHAMBER (19) THAT IN ITS INTERIOR CONTAINS A PULLEY SYSTEM (NOT ILLUSTRATED) THAT SPIN TO OPEN AND TO CLOSE THE DOOR; A FIRST SPRING (20) AND A SECOND SPRING (21) LIGHTLY LESS IN ITS THICKNESS THAN THE FIRST SPRING, WHICH GIVE THE STRENGTH AND THRUST AT DOOR'S OPENING AND DOOR'S CLOSING; A CLOSING SPEED-REGULATION VALVE (22) ACTIVATED VIA WRENCH, A BREAK SPEED-REGULATION VALVE (23) ACTIVATED VIA WRENCH; A HYDRAULIC FLUID THAT LETS DO THE NECESSARY PRESSURE IN THE SPRINGS SO THE SPRINGS RETURN TO THEIR ORIGINAL POSITION IN A CONTROLLED WAY.

WITH REFERENCE TO FIG. 4, THE HYDRAULIC PIVOT FOR DOORS CHARACTERIZED BY A TOP PIVOT THAT COMPREHENDS A RECTANGULAR COUPLING BODY (24), TOP COVER (25) THAT IT COMPREHENDS A CENTRAL RECTANGULAR OPENING (26), A COUPLING HOLE (27) FOR THE TOP STRIKE PLATE; THREE ASSEMBLY HOLES (28) LOCATED ON THE RIGHT SIDE OF THE COVER; A LEFT-LATERAL LAMINATED-PLATE (29) WITH A WRENCH'S INTRODUCTION HOLE (30) LOCATED IN THE TOP COVER, THREE ASSEMBLY HOLES (31) LOCATED IN THE LOWER PART.

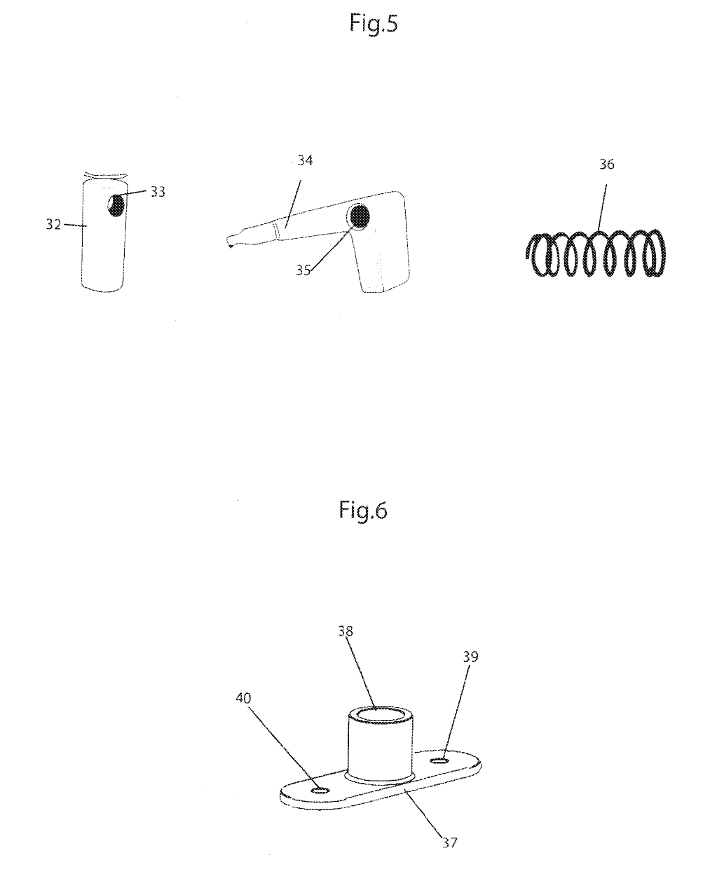

WITH REFERENCE TO FIG. 5, THE HYDRAULIC PIVOT FOR DOORS CHARACTERIZED BECAUSE IN THE RECTANGULAR HOUSING BODY COMPREHENDS A SMALL CHAMBER THAT IN ITS INTERIOR IT HOUSES A SCREW BOLT WITH AN ASSEMBLY HOLE (33), LOCATED IN THE TOP PART WHERE IT COUPLES AN ARROW (34) WITH A WRENCH COUPLING OPENING (35), THE ARROW HOUSES A LENGTHLY SPRING, THAT WHEN IT IS ACTIVATED VIA WRENCH WITH A RIGHT SPIN, IT EXERCISES PRESSURE TO THE SPRING THAT MAKES THE SCREW BOLT TO RISE OR TO LOWER THE NECESSARY HEIGHT TO FIT IN THE TOP STRIKE PLATED (37).

WITH REFERENCE TO FIG. 6, THE HYDRAULIC PIVOT FOR DOORS CHARACTERIZED BECAUSE IT COMPREHENDS A TOP PIVOT STRIKE PLATE (37) WITH A COUPLING HOLE (38) THAT IT AXIALLY EXTENDS FROM THE LOWER PART TO THE TOP PART, A RIGHT-LATERAL HOLE (39) FOR FIXATION, A SECOND LEFT-LATERAL HOLE (40) FOR FIXATION. THE HYDRAULIC PIVOT IS DESIGNED TO FUNCTION IN DOORS WITH WEIGHTS UP TO 100 KILOGRAMS, IT PROVIDES SUPPORT, AND IT CONTROLS THE OPENING AND THE CLOSING.

1. A HYDRAULIC PIVOT FOR DOORS THE HYDRAULIC PIVOT COMPRISING:
A LOWER PIVOT;
A RECTANGULAR HOUSING BODY;
A STRIKE PLATE WITH A CENTRAL OPENING;
A THREATED REGION, WHEREIN THE A THREATED REGION INCLUDES FOUR HOLES; AND FOUR ADJUSTMENT SCREWS;
AN ASSEMBLY THREADED REGION, WHEREIN THE AN ASSEMBLY THREADED REGION INCLUDES FOUR METAL STUDS;
TWO PROTECTIVE TOPS;
A LEFT-LATERAL PROTECTIVE LAMINATED-PLATE;
A SQUARE-SHAPE ASSEMBLY LAMINATED-PLATE;
A LAMINATED-PLATE WITH SEMICIRCLE ENDINGS THAT INCLUDES FIVE COUPLING HOLES;
A CHAMBER, WHEREIN THE CHAMBER CONTAINS A PULLEY SYSTEM CAPABLE OF SPINNING WHEN OPENING AND CLOSING;
A FIRST SPRING HAVING A FIRST THICKNESS:
A SECOND SPRING HAVING A SECOND THICKNESS, WHEREIN THE SECOND THICKNESS OF THE SECOND SPRING IS LESS THAN THE FIRST THICKNESS OF THE FIRST SPRING;
A CLOSING SPEED-REGULATION VALVE ACTIVATED VIA A WRENCH;
BREAKING SPEED-REGULATING VALVE, ACTIVATED VIA A WRENCH;
HYDRAULIC FLUID THAT ALLOWS PRESSURE IN THE FIRST AND SECOND SPRINGS SO THE FIRST AND SECOND SPRINGS RETURN TO THEIR ORIGINAL POSITION IN A CONTROL MANNER;
A TOP PIVOT THAT INCLUDES A RECTANGULAR HOUSING BODY;
A SMALL CHAMBER THAT INCLUDES A SCREW BOLT WITH AN ASSEMBLY HOLE, LOCATED ON THE TOP PART;
AN ARROW THAT INCLUDES A HOUSING OPENING;
A THIRD SPRING WHEREIN WHEN THE THIRD SPRING IS ACTIVATED VIA A WRENCH WITH A RIGHT-SPIN, THE THIRD SPRING EXERCISES PRESSURE TO RAISE OR LOWER THE SCREW BOLT TO THE NECESSARY HEIGHT UNTIL THE SCREW BOLT SHEATHES IN THE TOP PIVOT STRIKE PLATER;
A COUPLING HOLE THAT EXTENDS AXIALLY FROM THE LOWER PART TO THE TOP PART;
A RIGHT LATERAL HOLE FOR FIXATION;
A SECOND LEFT LATERAL HOLE FOR FIXATION.

2. THE HYDRAULIC PIVOT FOR DOORS ACCORDING TO CLAIM 1, WHEREIN
THE HYDRAULIC PIVOT SUPPORTS DOORS WITH A WEIGHT UP TO 100 KILOGRAMS.

3. THE HYDRAULIC PIVOT FOR DOORS ACCORDING TO CLAIM 1, WHEREIN
THE LOWER PIVOT INCLUDES A RIGHT LATERAL HOLE TO INSERT A WRENCH THAT SPINS TO THE LEFT TO REGULATE THE CLOSING SPEED.

4. THE HYDRAULIC PIVOT FOR DOORS ACCORDING TO CLAIM 1, WHEREIN
THE LOWER PIVOT INCLUDES A LEFT LATERAL HOLE TO INSERT THE WRENCH TO SPIN TO THE RIGHT TO CONTROL THE BREAK'S SPEED.

5. THE HYDRAULIC PIVOT FOR DOORS ACCORDING TO CLAIM 1, WHEREIN
THE TOP PIVOT INCLUDES A CENTRAL RECTANGULAR OPENING, A COUPLING HOLE TO THE TOP STRIKE PLATE, AND THREE ASSEMBLY HOLES.

6. THE HYDRAULIC PIVOT FOR DOORS ACCORDING TO CLAIM 1, WHEREIN
THE TOP PIVOT INCLUDES A LEFT SIDE LAMINATED-PLATE, A WRENCH'S INSERT HOLE THAT RIGHT-SPINS THAT ACTIVATES THE INTERIOR SPRING OF THE ARROW TO RISE OR LOWER THE SCREW BOLT UNTIL THE SCREW BOLT SHEATHES IN THE TOP STRIKE PLATE, AND THREE ASSEMBLY HOLES.
